(19) United States
(12) Patent Application Publication
(10) Pub. No.: US 2006/0061587 A1
(43) Pub. Date: Mar. 23, 2006

(54) Processor and a Related Method for Adjusting Color Attributes of a Pixel

(76) Inventors: Chia-Lei Yu, Taipei City (TW); Tsorng-Yang Mei, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/161,684

(22) Filed: Aug. 12, 2005

(30) Foreign Application Priority Data
Sep. 20, 2004 (TW) 093128443

(51) Int. Cl. G09G 5/02

(52) U.S. Cl. 345/604

(57) ABSTRACT

A processor and a related method for adjusting color attributes of pixels are introduced. The method includes examining color attributes of pixels within a range in an image, examining color attributes of a first number of pixels around a first pixel when color attributes of the first pixel conform to a predetermined range, and adjusting the color attributes of the first pixel according to a predetermined rule when color attributes of a second number of pixels among the first number of pixels conform to the predetermined range. The claimed method differentiates the correct image signals from the noise by examining color attributes of surrounding pixels, and only applies adjustment to the correct image signals, avoiding making unnecessary adjustments to the noise signals.

### BACKGROUND OF THE INVENTION

1. Field of the Invention

The present invention relates to a processor and related method for adjusting color attributes of a pixel; and more particularly, to a processor and related method for adjusting color attributes of a target pixel referring to color attributes of a plurality of pixels around the target pixel.

2. Description of the Prior Art

The transmission bandwidth for image signals is usually limited. To minimize transmission bandwidth, image signals usually need to be encoded for transmission and hence need to be decoded after being received for further processing. Therefore, the coloring of images is easily distorted, especially in the color range of human skin tones, which is the easiest to observe. In the prior art, methods are utilized to find pixels with color attributes that conform to the range of human skin tones and to adjust the color attributes of those pixels to compensate for the distortion.

Please refer to FIG. 1. FIG. 1 is a flowchart of a prior art method for adjusting color attributes of pixels.

Step 10: Start;

Step 11: If all pixels of an image have been examined, perform Step 19; otherwise perform Step 12;

Step 12: Examine color attributes of an unexamined pixel;

Step 13: If the color attributes of the pixel conform to a predetermined range, perform Step 14; otherwise perform Step 11;

Step 14: Adjust the color attributes of the pixel according to a predetermined rule;

Step 19: End.

In the prior art method shown in FIG. 1, each pixel is examined individually in order. However, in typical images, pixels having similar color attributes generally appear in groups rather than individually and possible that when a pixel with distinct color attributes appears alone, it is not a correctly colored pixel but rather is noise. However, when the prior art method for adjusting color attributes of pixels is utilized, such individual pixels are selected as also conforming to the predetermined range of color attributes, and hence the system will adjust these noise pixels as well. The processing resources are, consequently, wasted due to the unnecessary adjustment of such noise signals.

### SUMMARY OF THE INVENTION

It is therefore a primary objective of the claimed invention to provide a processor and a related method for adjusting color attributes of a target pixel The present invention determines whether the target pixel needs to be adjusted or is simply noise by referring to the target pixel and color attributes of a plurality of pixels around the target pixel.

Briefly described, the claimed invention discloses a method for adjusting color attributes of pixels. The method includes examining color attributes of pixels within a range in an image, examining color attributes of a first number of pixels around a first pixel when color attributes of the first pixel conform to a predetermined range, and adjusting the color attributes of the first pixel according to a predetermined rule when color attributes of a second number of pixels among the first number of pixels conform to the predetermined range.

The claimed invention further discloses a processor for adjusting color attributes of pixels. The processor includes an examining unit, a logic unit coupled to the examining unit, and an adjusting unit coupled to the logic unit. The examining unit is for examining color attributes of pixels within a range in an image, and for examining color attributes of a first number of pixels around a first pixel when color attributes of the first pixel conform to a predetermined range. The logic unit is for receiving an examining result from the examining unit, and for generating an adjustment command when color attributes of a second number of pixels among the first number of pixels conform to the predetermined range. The adjusting unit is for adjusting the color attributes of the first pixel according to the adjustment command.

It is an advantage of the present invention that the target pixel is examined with regard to the color attributes of surrounding pixels, such that noise pixels are not selected as targets to be adjusted; hence, the operational load is reduced.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of a prior art method for adjusting color attributes of pixels.

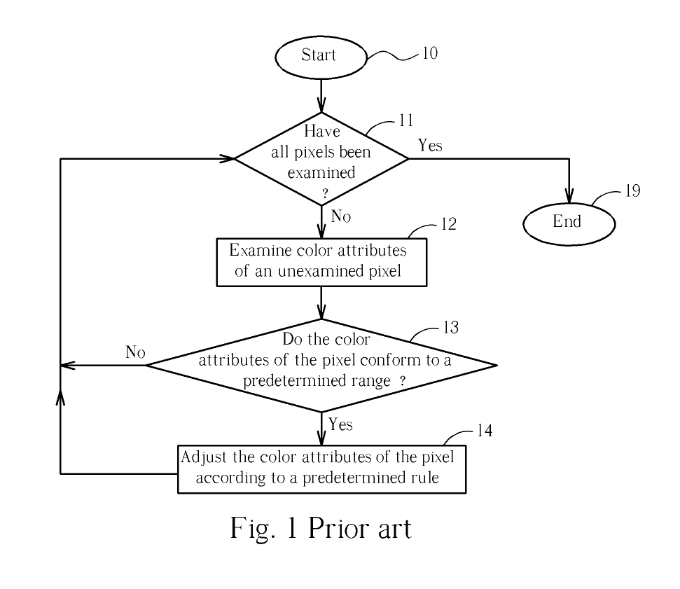

FIG. 2 is a flowchart of the present invention method for adjusting color attributes of pixels.

FIG. 3 is a diagram of the first distribution of pixels.

FIG. 4 is a diagram of the second distribution of pixels.

FIG. 5 is a diagram of the third distribution of pixels.

FIG. 6 is a diagram of the fourth distribution of pixels.

FIG. 7 is a diagram of the fifth distribution of pixels.

FIG. 8 is a diagram of the sixth distribution of pixels.

FIG. 9 is a diagram of the seventh distribution of pixels.

FIG. 10 is a diagram of the eighth distribution of pixels.

FIG. 11 is a diagram of the ninth distribution of pixels.

FIG. 12 is a diagram of the tenth distribution of pixels.

FIG. 13 is a diagram of the eleventh distribution of pixels.

FIG. 14 is a diagram of the twelfth distribution of pixels.

FIG. 15 is a diagram of the thirteenth distribution of pixels.

FIG. 16 is a block diagram of a processor of the present invention.

### DETAILED DESCRIPTION

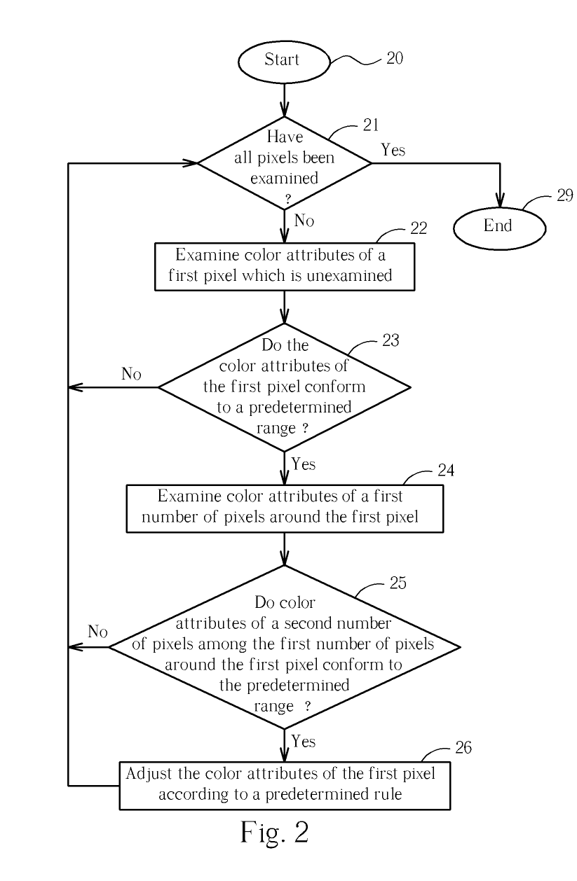

In common images, pixels of the same color attributes generally appear in a group instead of individually. Therefore the present invention determines whether a target pixel needs to be adjusted or is simply noise by referring to color attributes of surrounding pixels. Please refer to FIG. 2, which is a flowchart of the present invention method for adjusting color attributes of pixels.

Step 20: Start;

Step 21: If all pixels have been examined, perform Step 29; otherwise perform Step 22;

Step 22: Examine color attributes of a first pixel which is unexamined;

Step 23: If the color attributes of the first pixel conform to a predetermined range, perform Step 24; otherwise perform Step 21;

Step 24: Examine color attributes of a first number of pixels around the first pixel;

Step 25: When color attributes of a second number of pixels among the first number of pixels around the first pixel conform to the predetermined range, perform Step 26; otherwise perform Step 21;

Step 26: Adjust the color attributes of the first pixel according to a predetermined rule;

Step 29: End.

In the flowchart of the present invention method for adjusting color attributes of pixels illustrated in FIG. 2, a pixel is determined to be adjusted when its color attributes conform to a predetermined range, and when color attributes of a second number of pixels among a first number of surrounding pixels conform to the predetermined range at the same time. In practical implementation, besides sufficient number of surrounding pixels that have the same color attributes, the distribution of the second number of pixels can be examined in Step 25 for a more accurate determination.

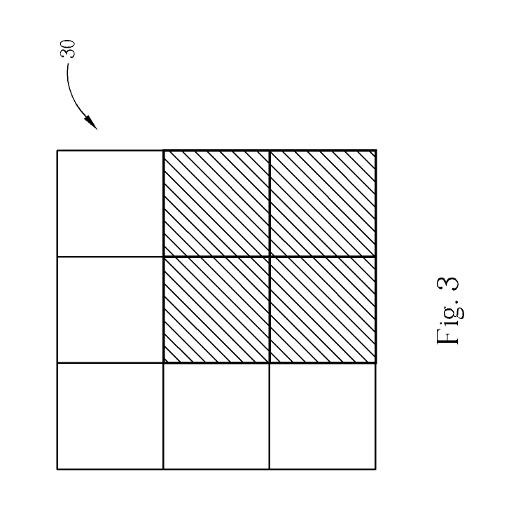

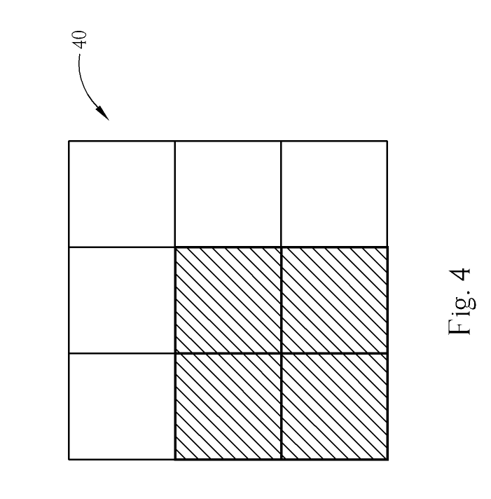

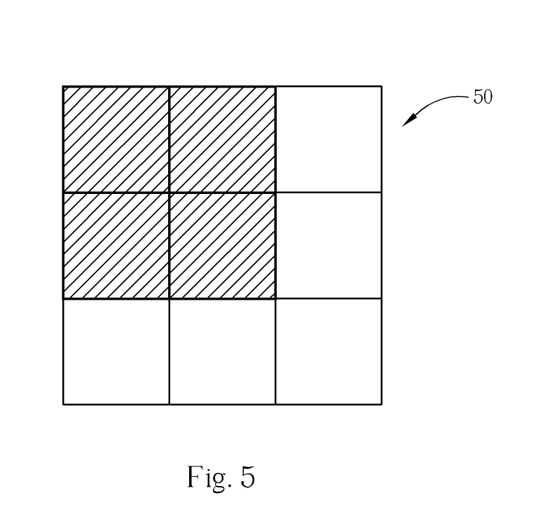

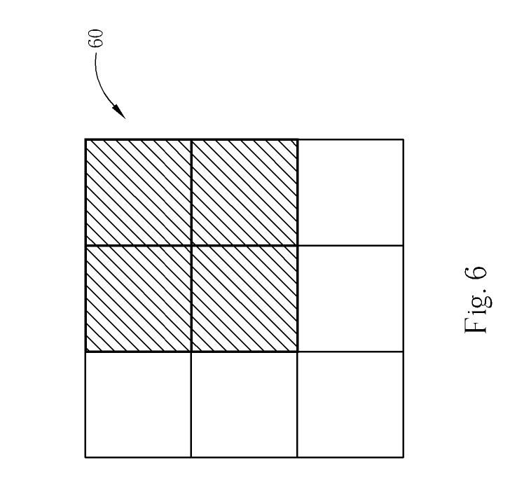

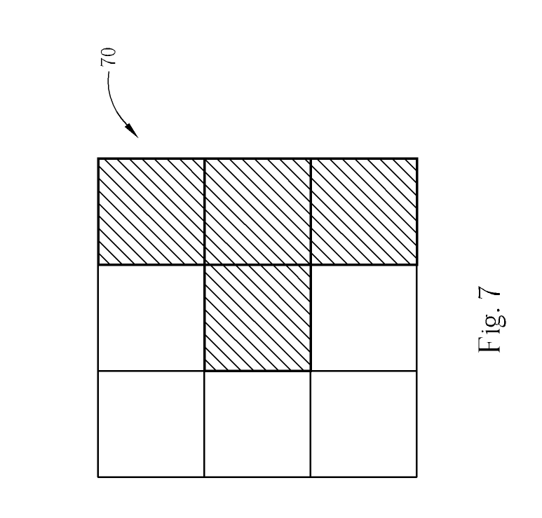

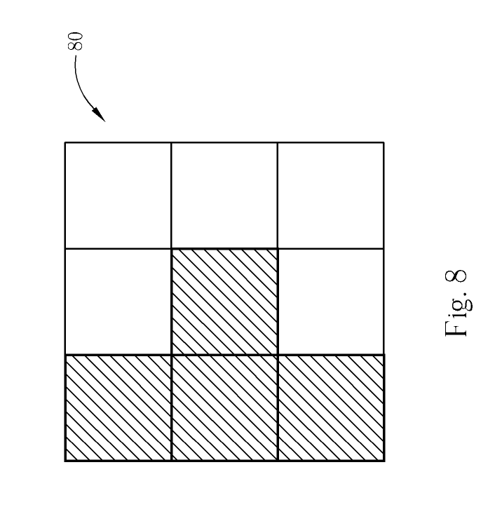

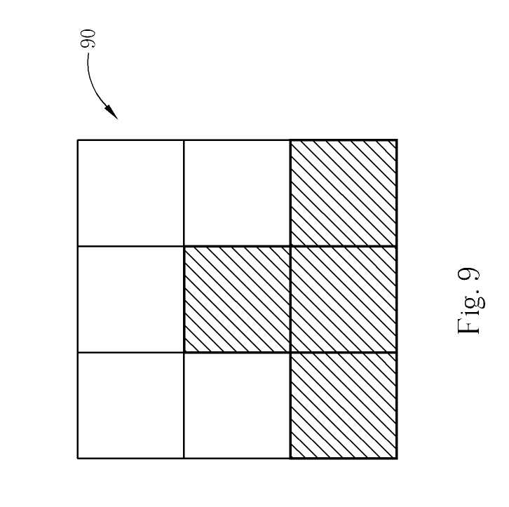

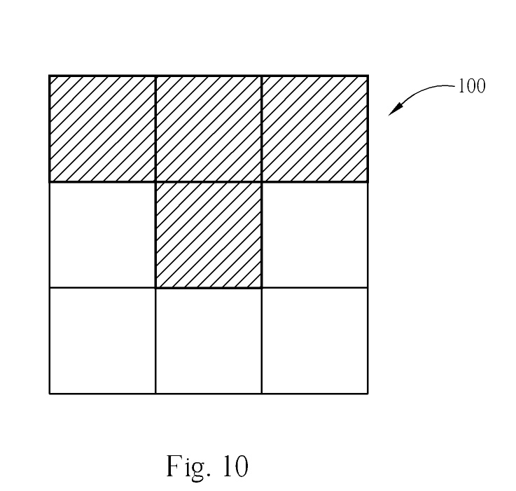

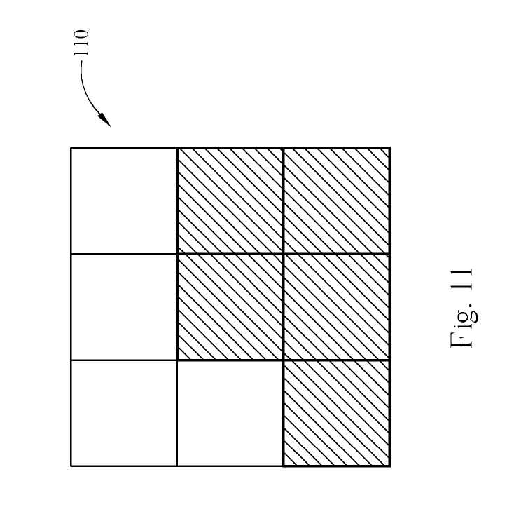

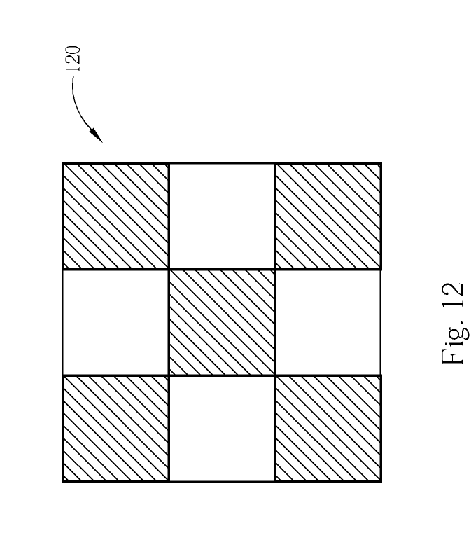

Please refer to FIGS. 3 through 10. 30, 40, 50, 60, 70, 80, 90 and 100 show a central pixel and its eight nearest surrounding pixels. In each figure of FIGS. 3 through 10, the central square represents the target pixel being examined. The shaded squares represent pixels in which the color attributes conform to a predetermined range. Assuming the rule chosen for determining whether a target pixel needs to be adjusted is: when among the eight nearest pixels, there are at least three pixels of which their color attributes conform to the predetermined range, and each of the three pixels is next to at least one other pixel among said three pixels, then the target pixel needs to be adjusted. FIGS. 3 to FIG. 10 show eight distributions for which the color attributes of the central square (the target pixel) are determined to need to be adjusted. Please refer to FIG. 11. In FIG. 11, the central square also represents the pixel to be examined. The set 110 includes the central target pixel and eight nearest surrounding pixels. The shaded squares represent pixels for which the color attributes conform to a predetermined range as well. For example, if color attributes of the target pixel are examined and are found to conform to a predetermined range, such as a range of the Mongolian skin tone, in Step 22 of the present invention method illustrated in FIG. 2, the eight nearest pixels of the target pixel will be examined in step 24. If there are four pixels of which the color attributes conform to the range of the Mongolian skin tone among the eight pixels, and if the distribution of the four pixels is as illustrated in FIG. 11, then the color attributes of the target pixel will be adjusted in Step 26 since the distribution of FIG. 11 conforms to the distribution of FIG. 3. Please refer to FIG. 12. Similar to FIGS. 3 Through 11, the set 120 includes a central target pixel and the eight nearest surrounding pixels. The shaded squares represent pixels of which the color attributes conform to a predetermined range. In set 120, the color attributes of the target pixel conform to the range of the Mongolian skin tone, and there are more than three pixels of which the color attributes conform to the range of the Mongolian skin tone among the eight surrounding pixels, but the distribution of the more than three pixels does not conform to the aforementioned rule as illustrated in FIG. 12, the target pixel (the central square) will be determined to be a noise signal and not as a pixel to be adjusted.

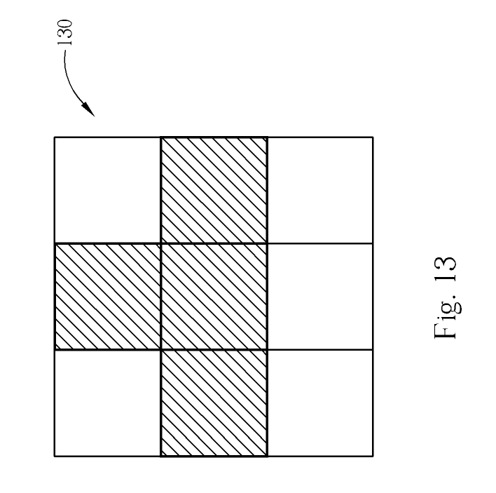

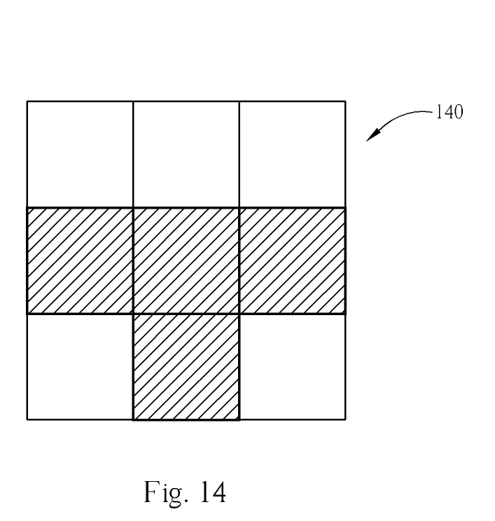

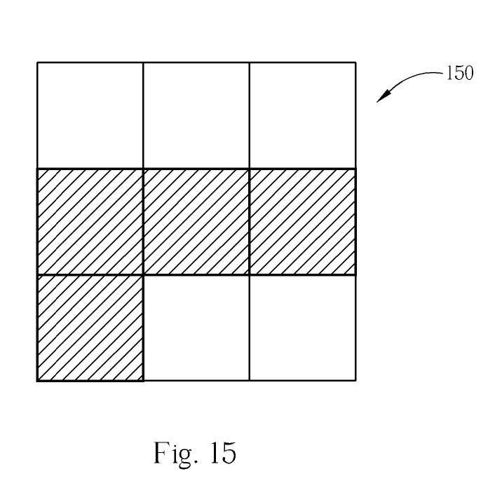

If the chosen determining rule of distribution is that each of the second number of pixels must be neighbors to the target pixel, but each of the second number of pixels does not need to be a neighbor to at least one other pixel of the second number of pixels, then the limitation for determining which pixels are to be adjusted is loosened. Please refer to FIGS. 13 through 15. The central square again represents the target pixel to be examined. Each of the sets 130, 140 and 150 includes a target pixel and the eight nearest pixels. A shaded square indicates that the color attributes of the pixel represented by the square conform to a predetermined range. Assume the chosen determining rule is that among the eight nearest pixels of the center pixel, there are at least three pixels for which their color attributes conform to the predetermined range. Therefore, in FIG. 13 and FIG. 14, the center pixel is adjusted in step 26, since the central pixel (the target pixel) has three surrounding pixels for which the color attributes conform to the predetermined range (represented by shading), although the three surrounding pixels are not adjacent to one another. As for FIG. 15, the distribution of the three surrounding pixels for which the color attributes conform to the predetermined range (represented by shading) also conforms to the aforementioned determining rule: each of the three surrounding pixels is adjacent to the central pixel and is adjacent to another pixel among the three pixels. Therefore, the target pixel of the set 150 illustrated in FIG. 15 is determined to be a pixel that needs to be adjusted, rather than being noise.

When the present invention processor determines that the target pixel conforms to the chosen determining rule in step 25 of FIG. 2, the present invention processor adjusts the color attributes of the target pixel according to a predetermined rule in step 26, and optionally it can adjust the color attributes of the surrounding pixels in which the color attributes conform to the predetermined range as well. The advantage of the former method is that the operation of the system hardware is simple and regular for adjusting the target pixel only. On the other hand, the advantage of the latter method is that a marginal pixel of a color block can be adjusted before it is selected as the target pixel. Otherwise, when the marginal pixel of the color block is selected as the target pixel, there might be not enough surrounding pixels of which the color attributes conform to the predetermined range, and hence the marginal pixel will be determined to be noise and not a correct pixel to be adjusted. Furthermore, the adjustment utilized in the present invention can include adjusting the luminance (lightness), hue, and/or saturation. For skin tone calibration, the most common adjustment is to raise the luminance of pixels to increase brilliance. The adjusted color attributes can usually be included in the same predetermined range of color attributes since the amendment is very slight, only to correct the distortion due to transmission. Therefore, when a different pixel is later selected as a new target pixel and is being examined, the color attributes of the surrounding pixels that have already been adjusted still conform to the predetermined range, and the new target pixel will not be erroneously determined to be a noise signal. The calibration range of color attributes, the means of determination, and the adjusting rule can be fixed in a system, or can be assigned by users through a user interface. For the latter way, a step for assigning the predetermined rule needs to be inserted into the process in front of Step 21 of the flow shown in FIG. 2.

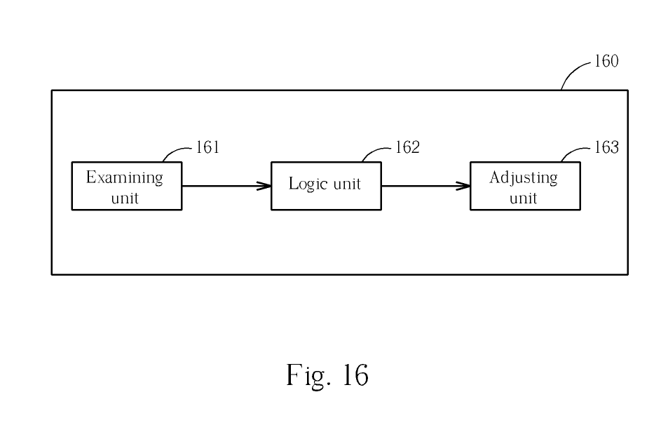

Please refer to FIG. 16. FIG. 16 is a block diagram of the present invention processor 160 for adjusting color attributes of pixels. The processor 160 is utilized to implement the claimed method of adjusting color attributes of pixels. The processor 160 includes an examining unit 161, a logic unit 162 and an adjusting unit 163. The examining unit 161 is utilized to examine color attributes of a first pixel in an image, and to examine color attributes of a first number of pixels around the first pixel when the color attributes of the first pixel are found to conform to a predetermined range. The logic unit 162 is coupled to the examining unit 161 for receiving the examining result from the examining unit, and for generating an adjustment command when color attributes of a second number of pixels among the first number of pixels conform to the predetermined range. The adjusting unit 163 is coupled to the logic unit 162 for adjusting the color attributes of the first pixel according to the adjustment command generated by the logic unit 162. The processor 160 can further include a user interface in order to select or set the calibration settings such that the calibrating range of color attributes can be set by the user. The present invention can be implemented by an application specific integrated circuit (ASIC), or by a processor of a system such as a personal computer (PC) for performing a program.

In summary, the present invention provides a processor for adjusting color attributes of pixels and related methods, utilizing a simple algorithm to determine whether a pixel needs to be adjusted or is simply noise. The operating resources that used to be wasted inevitably due to the unnecessary adjustment of noise signals is now saved. The present invention can be applied to implement skin-tone calibration, blue stretch, green enhancement, or any specific calibration.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for adjusting color attributes of pixels comprising:
examining color attributes of pixels within a range in an image;
examining color attributes of a first number of pixels around a first pixel when color attributes of the first pixel conform to a predetermined range; and
adjusting the color attributes of the first pixel according to a predetermined rule when color attributes of a second number of pixels among the first number of pixels conform to the predetermined range.

2. The method of claim 1 further comprising:
adjusting color attributes of the second number of pixels of which the color attributes conform to the predetermined range according to the predetermined rule when color attributes of the second number of pixels among the first number of pixels conform to the predetermined range.

3. The method of claim 1 wherein the color attributes of the first pixel adjusted according to the predetermined rule conform to the predetermined range.

4. The method of claim 1 comprising adjusting the color attributes of the first pixel according to the predetermined rule when color attributes of the second number of pixels among the first number of pixels conform to the predetermined range and a distribution of the second number of pixels conforms to a predetermined distribution rule.

5. The method of claim 4 comprising adjusting the color attributes of the first pixel according to the predetermined rule when color attributes of the second number of pixels among the first number of pixels conform to the predetermined range, and the second number of pixels are adjacent to the first pixel.

6. The method of claim 1 wherein the step of examining color attributes of a first number of pixels around a first pixel when color attributes of the first pixel conform to a predetermined range comprises examining color attributes of eight pixels that are closest to the first pixel.

7. The method of claim 1 wherein the step of adjusting the color attributes of the first pixel according to the predetermined rule comprises adjusting lightness, hue and saturation of the first pixel.

8. The method of claim 1 further comprising setting the predetermined rule.

9. A processor for adjusting color attributes of pixels comprising:
an examining unit for examining color attributes of pixels within a range in an image, and for examining color attributes of a first number of pixels around a first pixel when color attributes of the first pixel conform to a predetermined range;
a logic unit coupled to the examining unit for receiving an examining result from the examining unit, and for generating an adjustment command when color attributes of a second number of pixels among the first number of pixels conform to the predetermined range; and
an adjusting unit coupled to the logic unit for adjusting the color attributes of the first pixel according to the adjusting command.

10. The processor of claim 9 wherein the adjusting unit is further for adjusting color attributes of the second number of pixels according to the predetermined rule when color attributes of the second number of pixels among the first number of pixels conform to the predetermined range.

11. The processor of claim 9 wherein the color attributes of the first pixel conform to the predetermined range after being adjusted by the adjusting unit.

12. The processor of claim 9 wherein the logic unit generates the adjusting command when the color attributes of the second number of pixels conform to the predetermined range and a distribution of the second number of pixels conforms to a predetermined distribution rule.

13. The processor of claim 12 wherein the logic unit generates the adjusting command when the color attributes of the second number of pixels conform to the predetermined range and the second number of pixels are adjacent to the first pixel.

14. The processor of claim 9 wherein the examining unit is for examining color attributes of eight pixels that are closest to the first pixel.

15. The processor of claim 9 wherein the adjusting unit adjusts lightness, hue and saturation of the first pixel according to the adjusting command.

16. The processor of claim 9 further comprising a user interface for receiving an adjusting rule, wherein the adjusting unit is for adjusting color attributes of the first pixel according to the received adjusting rule.
